(19) United States
(12) Patent Application Publication
(10) Pub. No.: US 2011/0320056 A1
(43) Pub. Date: Dec. 29, 2011

(54) ELECTRIC VEHICLE SUPPLY EQUIPMENT WITH METERING AND COMMUNICATONS

(75) Inventors: Kenneth J. Brown, Chula Vista, CA (US); Carlos E. Ramirez, Tijuana (MX)

(73) Assignee: LEVITON MANUFACTURING CO., INC., Melville, NY (US)

(21) Appl. No.: 12/822,057

(22) Filed: Jun. 23, 2010

(51) Int. Cl. G06F 1/26; G06Q 30/00

(52) U.S. Cl. 700/295; 705/412

(57) ABSTRACT

An apparatus includes an electric vehicle supply circuit, and a communication interface coupled to the electric vehicle supply circuit. In some embodiments, the apparatus may be adapted to function as a node for a mesh network. In other embodiments, the communication interface may be adapted to communicate with a utility collection point using substantially the same protocol as the utility collection point. In yet other embodiments, the apparatus may be adapted to control the wireless communication interface in response to the state of the electric vehicle supply circuit.

### BACKGROUND

FIG. 1 illustrates a typical arrangement for charging an electric vehicle (EV) or plug-in hybrid electric vehicle (PHEV). Electric vehicle supply equipment (EVSE) 10 receives electric power from a utility grid or other source and transfers it to the vehicle 12 through a cord 14 and connector 16 that plugs into a mating inlet 18 on the vehicle. In this example, the AC power from the grid is converted to DC power by an on-board charger 20 in the vehicle to charge the battery 22. In an alternative arrangement, the charger may be located in the EVSE instead of the vehicle.

The EVSE, which is also referred to as supply equipment, a vehicle charger, a charging station, a charger, etc., may be realized in several different mechanical configurations. EVSE are frequently installed as wall-mounted units in garages and on buildings where vehicles can be parked inside or close to the building. In outdoor locations, especially parking lots and curbsides, EVSE are commonly installed on pedestals. EVSE may also take the form of a cord set which is sometimes referred to as a travel charger, portable charger, handheld charger, etc.

The connector 16 and inlet 18 typically utilize a conductive connection in which the electrical conductors in one connector make physical contact with the electrical conductors in the other connector. Other systems utilize inductive coupling in which energy is transferred through magnetic coils that are electrically insulated from each other.

To promote interoperability of vehicles and supply equipment, the Society of Automotive Engineers (SAE) has developed various standards that define mechanical configurations of connectors for charging vehicles, as well as the arrangement and function of electrical contacts within the connectors. One standard known as SAE J1772 is of particular interest because virtually every automaker in the U.S., Japan and Europe has announced plans to use J1772 compatible connectors for models sold in the U.S. This standard relates to conductive charging systems and covers both AC and DC connections.

FIG. 2 illustrates a reference design for a conductive vehicle charging system under the J1772 standard. A vehicle 30 is coupled to EVSE 28 through a coupling inlet 26 on the vehicle and coupling connector 24, which is typically connected to the EVSE through a flexible cord. AC power is transferred to the vehicle through terminals 1 and 2 of the coupling. A charging circuit interrupting device (CCID) 44 interrupts the flow of AC power if the difference between the current flowing in the two AC conductors exceeds a predetermined threshold, which typically indicates a potential ground fault condition. An on-board charger 32 in the vehicle converts the AC power to DC current for charging the battery 34.

Terminal 5 of the coupling connects safety grounding conductors in the EVSE and the vehicle. A control pilot signal is connected through terminal 6 and enables basic two-way communications between the EVSE and the vehicle. For example, the control pilot enables a charge controller 36 in the vehicle to determine the maximum amount of AC current available from the EVSE, while it enables the EVSE to determine if the vehicle requires ventilation for charging and if the vehicle is ready to receive power. The return path for the control pilot signal is through the grounding path which enables it to serve a safety function: if the safety pilot signal is not present, control electronics 42 in the EVSE assumes the ground path has been compromised and causes the CCID to interrupt the flow of AC power to the vehicle.

A proximity device 40 enables the vehicle to verify that it is mechanically connected to an EVSE system. The implementation details of proximity detection are left to the discretion of the manufacturer, but the J1772 standard identifies the use of magnetic proximity detectors as an acceptable technique. For AC charging, only terminals 1, 2, 5, and 6 are required. DC charging requires the use of optional terminals 3 and 4, as well as the establishment of a more sophisticated communication link through optional terminals 7-9 which are not illustrated.

The J1772 standard defines different types of charging including AC Level 1, which utilizes the most common 120 Volt, 15 Amp grounded receptacle, and AC Level 2, which utilizes a dedicated AC power connection at 208-240 Volts nominal and 32 Amps maximum. DC charging is defined as a method that utilized dedicated direct current (DC) supply equipment.

### BRIEF DESCRIPTION OF THE DRAWINGS

FIG. 1 illustrates a typical arrangement for charging an electric vehicle.

FIG. 2 illustrates a reference design for a conductive vehicle charging system.

FIG. 3 illustrates an embodiment of an electric vehicle supply circuit according to some inventive principles of this patent disclosure.

FIG. 4 illustrates another embodiment of an electric vehicle supply circuit according to some inventive principles of this patent disclosure.

FIG. 5 illustrates an embodiment of a controller according to some inventive principles of this patent disclosure.

FIG. 6 illustrates an example embodiment of a ground monitor circuit according to some inventive principles of this patent disclosure.

FIG. 7 illustrates an example embodiment of a ground fault detection circuit according to some inventive principles of this patent disclosure.

FIG. 8 illustrates an example embodiment of a contactor circuit according to some inventive principles of this patent disclosure.

FIG. 9 illustrates an example embodiment of a contact monitor circuit according to some inventive principles of this patent disclosure.

FIG. 10 illustrates an example embodiment of a fault detection circuit according to some inventive principles of this patent disclosure.

FIG. 11 illustrates a prior art home area network and utility network in a smart grid application.

FIG. 12 illustrates an embodiment of an apparatus and system according to some inventive principles of this patent disclosure.

FIG. 13 illustrates an embodiment of an EVSE system according to some inventive principles of this patent disclosure.

FIG. 14 illustrates an example embodiment of a mesh network system according to some inventive principles of this patent disclosure.

FIG. 15 illustrates an embodiment of a plug-in EVSE device according to some inventive principles of this patent disclosure.

FIG. 16 illustrates an embodiment of an EVSE wiring device according to some inventive principles of this patent disclosure.

FIG. 17 illustrates another embodiment of an EVSE wiring device according to some inventive principles of this patent disclosure.

FIG. 18 illustrates another example EVSE apparatus according to some inventive principles of this patent disclosure.

FIG. 19 is a state diagram that illustrates the operation of an embodiment of an EVSE system according to some inventive principles of this patent disclosure.

FIG. 20 illustrates an embodiment of an EVSE system having modular communications according to some inventive principles of this patent disclosure.

FIG. 21 illustrates an example embodiment of a module having wireless capability according to some inventive principles of this patent disclosure.

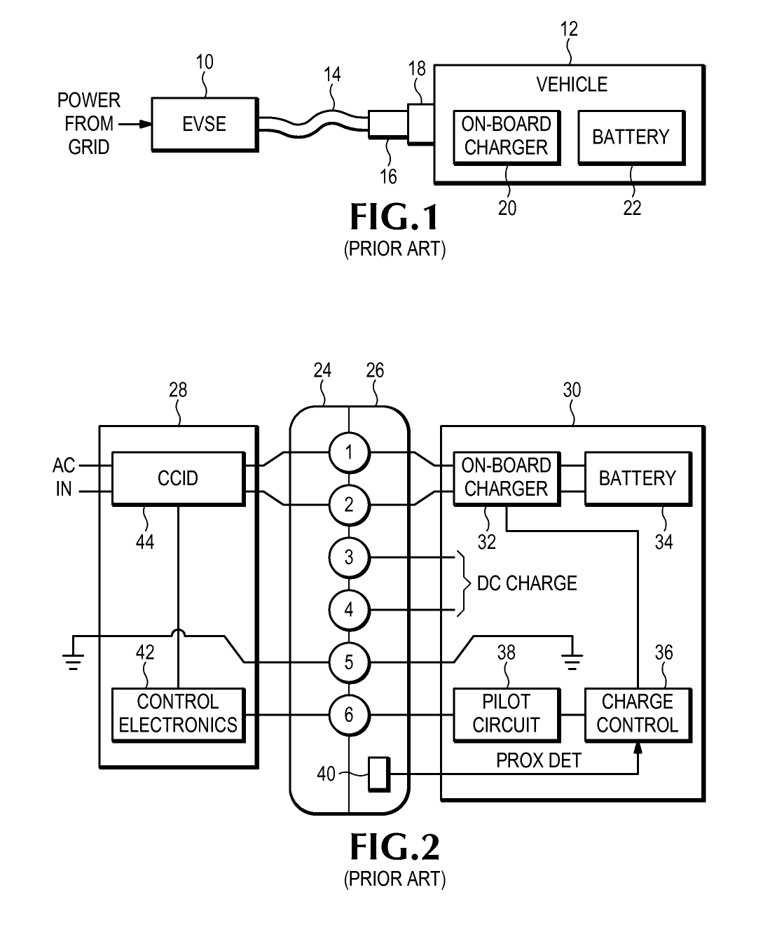

### DETAILED DESCRIPTION

For convenience, the term electric vehicle will be used to refer to pure electric vehicles (EVs), plug-in hybrid electric vehicles (PHEVs), and any other type of vehicle that utilizes electric charging unless otherwise apparent from context.

Some inventive principles of this patent disclosure relate to electric vehicle supply circuits for EVSE. An electric vehicle supply circuit is designed to provide power to an electric vehicle from a power source and includes at least an interrupting device and control circuitry to cause the interrupting device to interrupt the flow of power from the power source to the electric vehicle in response to conditions relevant to electric vehicles. Examples of conditions relevant to electric vehicles include a ground fault condition, an inoperable grounding monitor circuit, the absence of a vehicle connected to the EVSE, absence of a ready signal from the vehicle, etc.

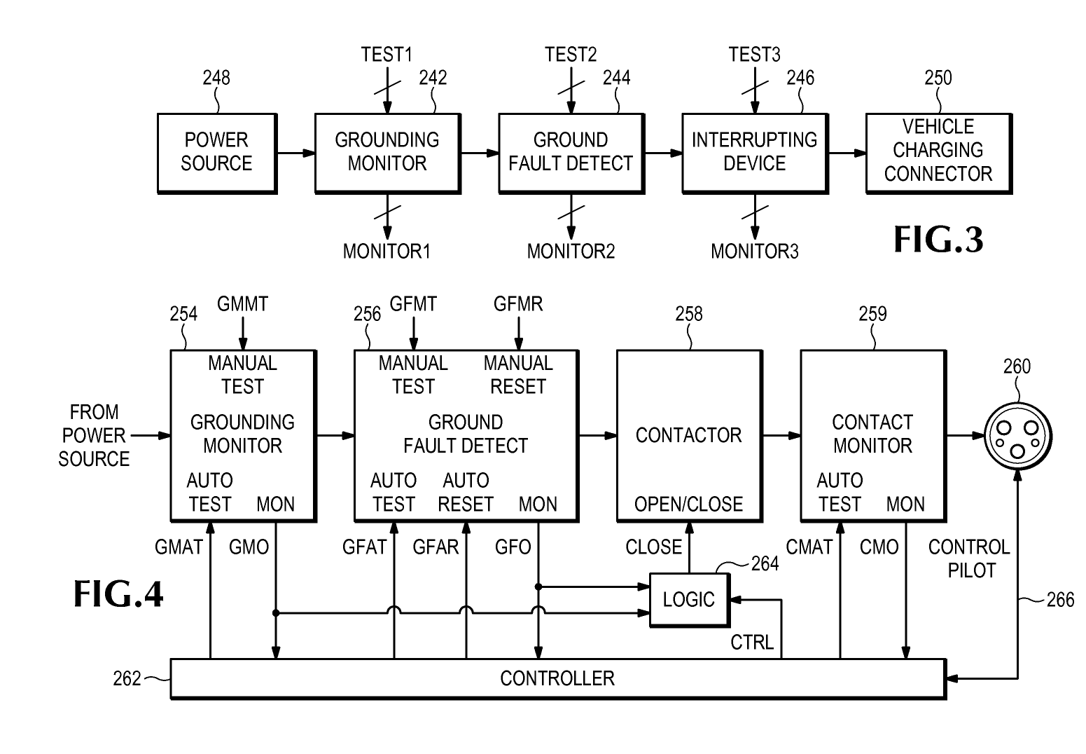

FIG. 3 illustrates an embodiment of an electric vehicle supply circuit according to some inventive principles of this patent disclosure. The embodiment of FIG. 3 includes a ground monitor 242, a ground fault detector 244, and an interrupting device 246 arranged along the power path between a power source 248 and a vehicle charging connector 250. The power path may accommodate AC and/or DC current flow. Any or all of the ground monitor, ground fault detector and/or interrupting device may include one or more test inputs TEST1, TEST2, TEST3, respectively, and one or more monitor outputs MONITOR1, MONITOR2, MONITOR 3, respectively. The test inputs may include any type of analog, digital or hybrid signals for initiating, controlling, resetting, etc., a testing operation. The monitor outputs may include any type of analog, digital or hybrid signals for monitoring, measuring, reporting, etc., a testing operation. Any of the testing and/or monitoring signals may operate manually, automatically, or in any other suitable manner. Not all of the elements are required in every embodiment, and the number, order and arrangement of elements may be changed.

The embodiment illustrated in FIG. 3 may provide a versatile framework for implementing an electric vehicle supply circuit adapted to any vehicle charging situation. For example, it may be used to implement a vehicle charging station under any of the standards currently published or under development such as UL 2231, IEC 61851-22, etc.

In the context of UL standards, the ground fault detector 244, and interrupting device 246, taken together, may be used to implement a charging circuit interrupting device (CCID) which is required to disconnect the source of power if the difference between the current flowing in the current-carrying conductors (differential current) exceeds a predetermined threshold. Any differential current is usually assumed to be caused by a ground fault which may present an electrocution hazard. This is essentially the same operating principle as a common ground fault circuit interrupter (GFCI) which is typically designed to interrupt the flow of power (trip) if the differential current exceeds 5 mA.

In the case of electric vehicle charging, however, 5 mA may be an unacceptably low trip point. Natural nonhazardous current paths through the vehicle to ground may routinely exceed 5 mA, thereby causing excessive nuisance tripping that interrupts the charging process. Therefore, UL standards allow a CCID to have a trip point of 20 mA if the system is equipped with a grounding monitor that interrupts the power circuit if it detects an inadequate grounding circuit. UL standards also require a CCID to allow for manual testing or automatic testing before each operation.

FIG. 4 illustrates another embodiment of an electric vehicle supply circuit according to some inventive principles of this patent disclosure. Power is provided by a power source which may include any suitable type of AC and/or DC power source. The power flows through a grounding monitor circuit 254, a ground fault detecting circuit 256, a contactor circuit 258, and a contact monitor circuit 259 on the way to a vehicle charging connector 260. These components may be reordered and/or rearranged in any suitable manner.

The grounding monitor circuit 254 monitors the continuity of a grounding conductor and generates an output signal GMO in response to the state of the grounding conductor. A manual test input GMMT enables the operation of the grounding monitor to be tested manually. An automatic test input GMAT enables the operation of the grounding monitor to be tested in response to an automatic test signal from a controller 262. The output signal GMO is provided to the controller 262 as well as logic 264.

The ground fault detecting circuit 256 monitors the differential current through the current carrying conductors and changes the state of the output signal GFO if the differential current exceeds a threshold. A manual test input GFMT enables the operation of the ground fault detector to be tested manually, while a manual reset input GFMR allows the detector to be reset manually. Automatic test input GFAT and automatic reset input GFAR enable the controller 262 to test and reset the ground fault detector. The output signal GFO is applied to the controller 262 as well as logic 264.

The contactor circuit 258 is arranged to close the circuit between the power source and the vehicle connector 260 in response to a CLOSE input signal from logic 264.

The contact monitor circuit generates an output signal CMO in response to the state of one or more switches in the contactor circuit 258. An automatic test input CMAT enables the controller 262 to test and monitor the contactor circuit.

A control pilot connection 266 enables the controller to determine whether a vehicle is connected to the supply circuit, to determine whether the vehicle is ready to receive power, to communicate the current capacity of the supply circuit to the vehicle, etc.

Logic 264 may be configured for interlocking operation. For example, the logic may be configured to assert the CLOSE signal only if the GMO signal indicates that the grounding monitor circuit is operating properly, the GFO signal indicates that no ground fault is present, and the controller asserts the CTRL signal.

The controller 262 may be configured to operate any or all of the features illustrated in FIG. 4. For example, the controller may be configured to test the grounding monitor 254, the ground fault detector 256 and/or the contactor circuit 258 and contact monitor 259 at power-up, each time power is applied to the vehicle, periodically while power is being supplied to the vehicle, etc. The contact monitor circuit enables the controller to monitor the presence of power to determine that the switch or switches in the contactor circuit 258 have actually closed when the CLOSE signal is activated and have actually opened when the CLOSE signal is deactivated and to provide a warning or take other suitable action if the actual state of the contactor circuit is incorrect or if some other fault causes the output power to be in an incorrect state.

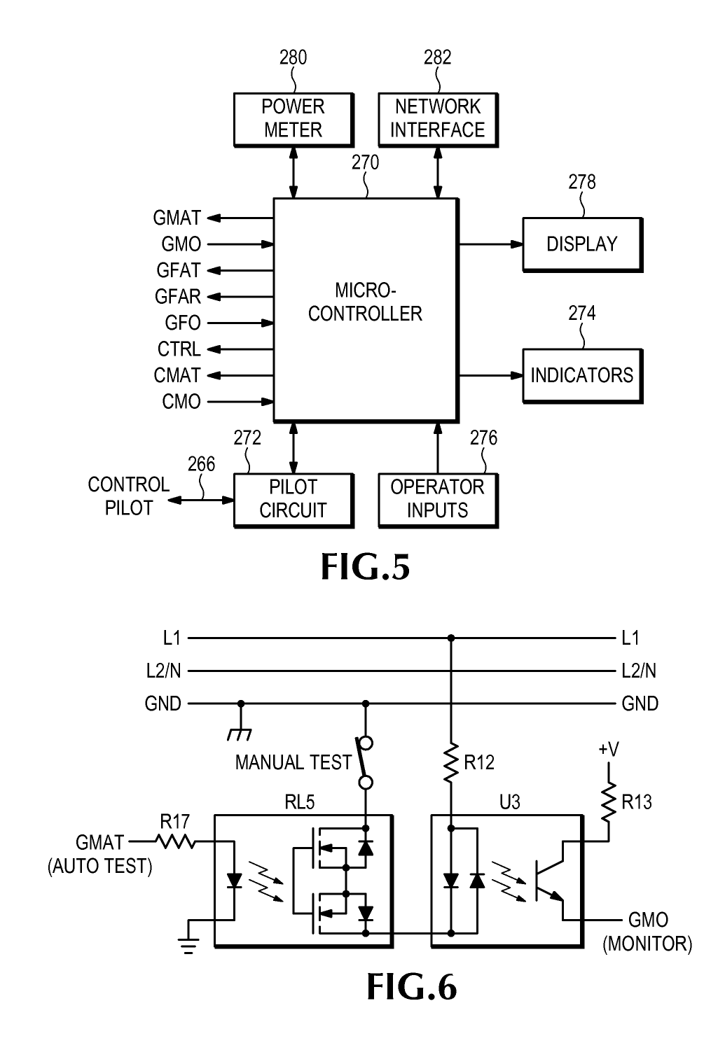

FIG. 5 illustrates an embodiment of a controller 262 according to some inventive principles of this patent disclosure. The controller is based on a microcontroller 270, although some or all of the functions of the controller may be implemented with any other suitable analog and/or digital hardware, software, firmware, etc., or any combination thereof. Not all of the elements shown in FIG. 5 are required in every embodiment, and the number, order and arrangement of elements may be changed.

The microcontroller 270 includes digital I/O lines coupled to the test, monitor and reset signals shown in FIG. 4. The controller may include filters, surge suppressors, buffers, amplifiers, comparators, level shifters, level detectors, additional logic, etc., to process these signals on their way to and from the microcontroller. A pilot circuit 272 provides functionality to enable the controller to determine whether a vehicle is connected to the supply circuit, to determine whether the vehicle is ready to receive power, to communicate the current capacity of the supply circuit to the vehicle, to monitor the integrity of the grounding connection, etc., through the control pilot connection 266.

Indicators 274 such as LEDs, lamps, etc. enable the controller to provide a visual indication of the operating condition of the vehicle supply circuit, fault conditions, etc. Some example indicators include a vehicle charging indicator and an EVSE fault indicator.

Operator inputs 276 such as switches, keypads, swipe cards, RFID devices, etc., enable a user to control the operation of the vehicle supply circuit. Some example inputs include switches to start/stop charging, switches to increase/decrease amperage, etc.

A display 278 enables the controller to provide more information to a user than may be conveyed through simple indicators. For example, an alphanumeric display may display vehicle charging current, voltage and/or power, percentage of charging completed, elapsed charging time, cost of power, etc. A display may also provide more detailed information about fault conditions and/or instructions for correcting faults.

A power meter 280 or other device may provide functionality to measure the amount of power transferred through the vehicle supply circuit, obtain authorization for power usage from a utility or other provider, facilitate off-peak rate reductions and/or demand response functions, etc. The power meter may be utility-grade for billing purposes, or it may be a convenience feature. It may be integral with the controller or separate from the controller, for example, in a tamper-proof enclosure. The power meter may be implemented, for example, with a dedicated integrated circuit (IC) such as a Microchip MCP3909 which may be mounted on a main circuit board with the microcontroller 270. Alternatively, the power meter may be arranged on a separate circuit board that may be attached to the main circuit board through a plug-in header to facilitate implementation of the power meter as an optional feature.

A network interface 282 may enable the controller to interface to any suitable network such as a local area network (LAN), wide area network (WAN), home network, the Internet, a control area network (CAN) or other industrial type control network, etc., through any type of network media and using any type of network protocol. Examples include dedicated wires, power line modulation, radio frequency (RF), infrared (IR), and other types of media, Internet Protocol (IP), WiFi, LonWorks, ZigBee, Z Wave, and other types of protocols.

The inventive principles described above with respect to the embodiments of FIGS. 3-5 may provide additional individual and collective benefits. For example, by providing automatic testing and/or monitoring of some or all of the vehicle supply circuit functions, the level of safety may be improved because the need for manual testing may be eliminated or reduced, and because it may be possible to implement more rigorous testing procedures. The inventive principles may also enable the implementation of self-diagnostics which may reduce the need for, or cost of, service and/or maintenance, as well as assist a user with troubleshooting the system.

FIG. 6 illustrates an example embodiment of a ground monitor circuit according to some inventive principles of this patent disclosure. In the embodiment of FIG. 6, conductors L1, L2/N and GND are shown passing through the circuit to help visualize the manner in which the circuit of FIG. 6 may be integrated with other circuits to create a complete system such as the ones illustrated in FIGS. 3 and 4. The inventive principles, however, are not limited to these specific details.

In a 120 VAC system, L1, N and GND may designate the hot, neutral and grounding conductors, respectively. In a 240 VAC system, L1, L2 and GND may designate the two hot conductors and the grounding conductor, respectively. Other systems, for example 3-phase power systems, may include different combinations of live and grounding conductors. In the circuit of FIG. 6, a monitor current path is established beginning with L1 and continuing through resistor R12, optocoupler U3, normally-closed solid state relay RL5, a normally closed manual test switch, and ending at the grounding conductor GND. During normal operation, if the grounding conductor GND remains electrically connected to ground potential, current flowing through the input side of optocoupler U3 turns on a phototransistor which pulls the ground monitor output signal GMO to a high logic level referenced to a logic supply voltage +V and an associated logic ground. This signal may be monitored by a controller to confirm that the grounding conductor GND is properly grounded. The monitor signal GMO may also be used by other logic circuitry to control the state of an interrupter circuit as illustrated in FIG. 4. Additional circuitry may be included between the GMO terminal and the controller such as voltage clamps, filters, resistive dividers, buffers, level detectors, etc.

Actuating the manual test switch interrupts the monitor current path and causes the optocoupler to stop pulling up the monitor signal GMO. The controller or other decision making circuit may respond to the change of state of GMO by interrupting the flow of power to a vehicle and/or any other suitable actions.

The solid state relay RL5 enables the ground monitor circuit to be tested automatically by a controller or any other suitable apparatus. A logic high on the automatic test signal GMAT turns the switch side of RL5 off, thereby interrupting the monitor current path and causing the optocoupler to stop pulling up the monitor signal GMO. This enables the controller to confirm the correct operation of the ground monitor circuit. In this case, rather than actuating a CCID, the controller may drive GMAT low again, and after confirming that GMO goes high again, return to a normal monitoring mode of operation.

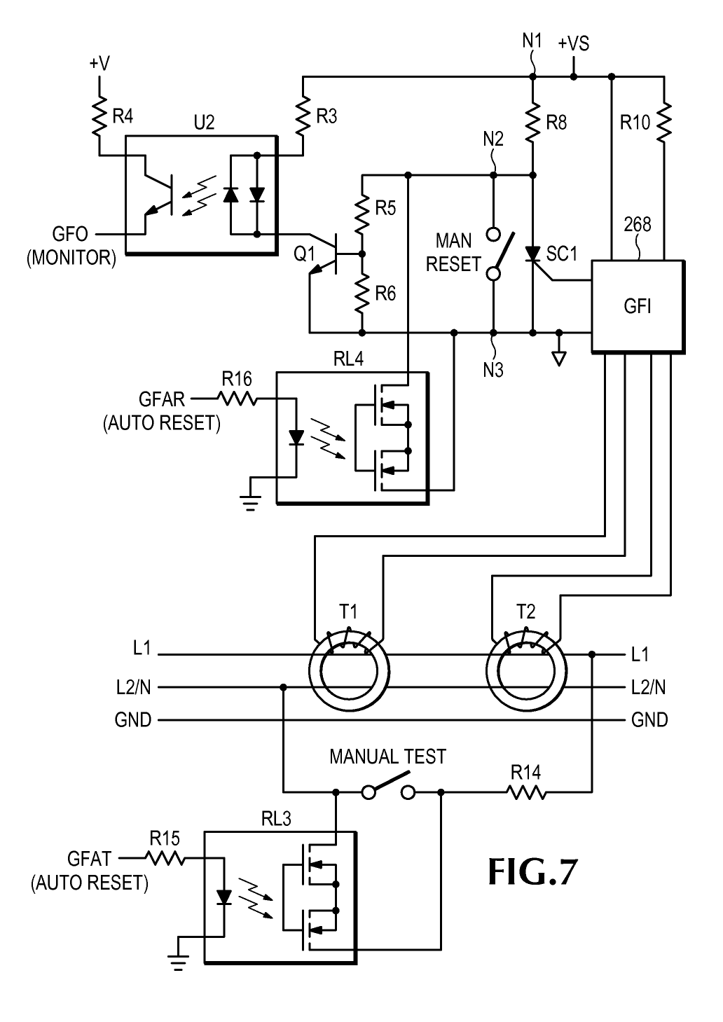

FIG. 7 illustrates an example embodiment of a ground fault detection circuit according to some inventive principles of this patent disclosure. In the embodiment of FIG. 7, conductors L1, L2/N and GND are again shown passing through the circuit to help visualize the manner in which circuit of FIG. 7 may be integrated with other circuits, but the inventive principles are not limited to these specific details.

The current carrying conductors L1 and L2/N both pass through a differential transformer T1 and neutral-ground (N-G) transformer T2, which are connected to a ground fault interrupter (GFI) circuit 268. The GFI circuit includes circuitry to detect differential currents flowing through L1 and L2/N and trigger the silicon controlled rectifier (SCR) labeled SC1 when the differential current exceeds a threshold determined by resistor R10. The GFI may be based on a commercial or special-purpose GFCI integrated circuit such as the LM1851 chip from National Semiconductor or the FAN1851 chip from Fairchild.

In a conventional ground fault detection circuit, the SCR actuates a latching relay arrangement. In the embodiment of FIG. 7, transistor Q1 is normally driven on by resistors R8, R5 and R6. When Q1 is on, a current set by R3 flows from the GFI supply +VS through the input side of optocoupler U2 which causes the phototransistor on the output of U2 to pull the ground fault monitor output GFO high through R4. The monitor signal GFO may then be used by a controller and/or logic circuitry to control the state of a contactor, relay or other interrupting circuit, and to perform reporting and/or other suitable actions in response to a ground fault detection.

When SC1 is triggered in response to a ground fault detection, it latches in the conductive state and causes Q1 to turn off, thereby causing the ground fault monitor signal GFO to go low. SC1 may be reset by closing the manual reset switch. A normally-open solid state relay RL4 enables the GFI circuit to be reset automatically by a controller and/or other decision making circuit or suitable apparatus in response to a ground fault automatic reset signal GFAR. A logic high on GFAR turns on the LED on the input side of RL4 through a current limiting resistor R16. Light from the LED turns on the FET switches on the output side of RL4, thereby resetting SC1.

The circuit of FIG. 7 may be tested by closing the manual test switch which shunts a current from L1 to L2/N without passing through the transformers T1 and T2, thereby simulating a ground fault condition. The amount of test current is determined by the value of resistor R14.

Another normally-open solid state relay RL3 enables the GFI circuit to be tested automatically by a controller and/or other decision making circuit or suitable apparatus by driving the ground fault automatic test signal GFAT with a logic high. A high signal on GFAT turns on the LED on the input side of RL3 through a current limiting resistor R15. Light from the LED turns on the FET switches on the output side of RL3, thereby causing a test current to flow through R14 without passing through the transformers T1 and T2.

The GFI supply +VS is referenced to a local ground connection at node N3 and may be provided, for example, by a rectifier bridge connected to the current carrying conductors L1 and L2/N. One or more resistors may be connected in series with the bridge to reduce the supply voltage to an acceptable level for the GFI circuit 268. For example, commonly available GFCI chips such as the LM1851 typically include an internal voltage regulator that clamps the supply voltage to about 26 Volts.

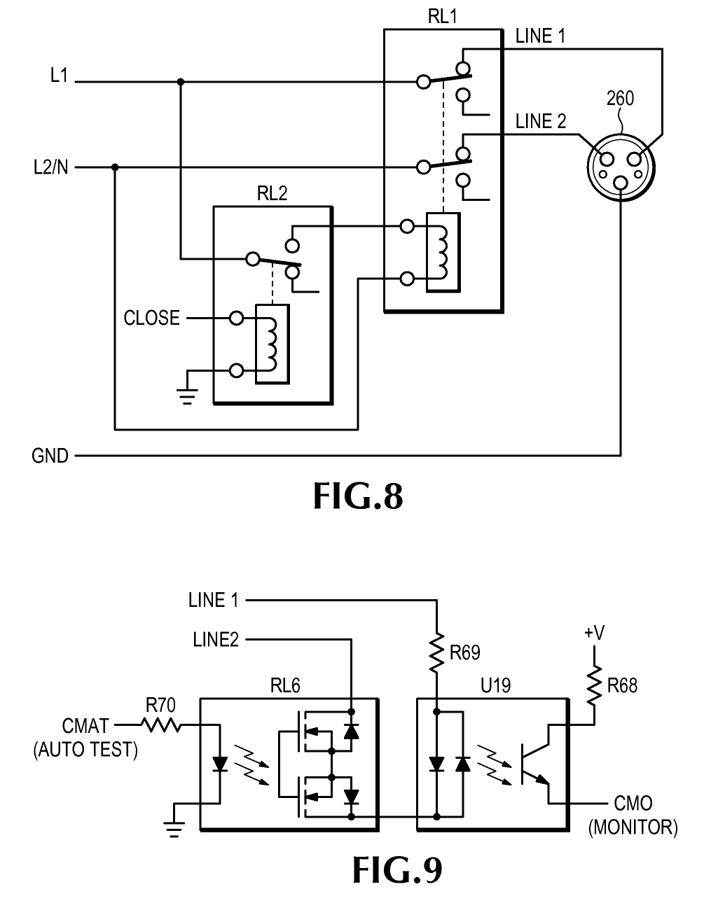

FIG. 8 illustrates an example embodiment of a contactor circuit according to some inventive principles of this patent disclosure. The embodiment of FIG. 8 includes a pilot relay RL2 to enable a low power logic signal CLOSE to operate a main relay RL1 which carries the fully AC charging current. The normally closed contacts of main relay RL1 are wired between the current carrying supply conductors L1 and L2/N and conductors LINE 1 and LINE 2 which transfer the AC power to a vehicle charging connector 260. The coil of RL1 is wired to the supply conductors through the normally closed contacts of the pilot relay RL2. Thus, when the CLOSE signal is low, current flows through RL2 and energizes the coil of RL1, thereby opening the normally closed contacts of RL1 and de-energizing the vehicle charging connector. When CLOSE goes high, the normally closed contacts of RL2 open and de-energize the coil of RL1, thereby closing the normally closed contacts of RL1 and energizing the vehicle charging connector.

FIG. 9 illustrates an example embodiment of a contact monitor circuit according to some inventive principles of this patent disclosure. In the circuit of FIG. 9, a monitor current path is established beginning at conductor LINE 1 and continuing through resistor R69, optocoupler U19, normally-closed solid state relay RL6, and ending at conductor LINE 2. The monitor circuit of FIG. 9 may be used, for example, to monitor the state of an EVSE main relay or contactor such as that illustrated in FIG. 8.

During normal operation, if the contacts of the monitored relay are closed and AC power is available, current flowing through the input side of optocoupler U19 turns on a phototransistor which pulls the contact monitor output signal CMO to a high logic level through resistor R68 referenced to a logic supply voltage +V and an associated logic ground. If the contacts are open and/or AC power is not available, no current flows through the monitor current path and the optocoupler stops pulling up the monitor signal CMO. The CMO signal may be monitored by a controller or other apparatus to confirm that the contacts are actually open or closed when expected.

The normally-closed solid state relay RL6 provides additional functionality by enabling an automatic test feature. During a time when AC power is expected on LINE 1 and LINE 2, the contact monitor automatic test signal CMAT may be driven high to turn the switch side of RL6 off, thereby interrupting the monitor current path and causing the optocoupler U19 to stop pulling up the monitor signal CMO. This enables a controller or other apparatus to confirm the correct operation of the contact monitor circuit.

In any of the embodiments of FIGS. 6-9, additional circuitry may be included between the monitor and/or test terminals and the controller and/or other apparatus such as voltage clamps, filters, resistive dividers, buffers, level detectors, etc.

Some additional inventive principles of this patent disclosure relate to fault circuit self-testing for EVSE. For purposes of illustration, some of the inventive principles are described in the context of a ground fault detector, but the inventive principles are also applicable to other types of fault circuits that may be used in EVSE such as arc fault detectors, over-current detectors, etc.

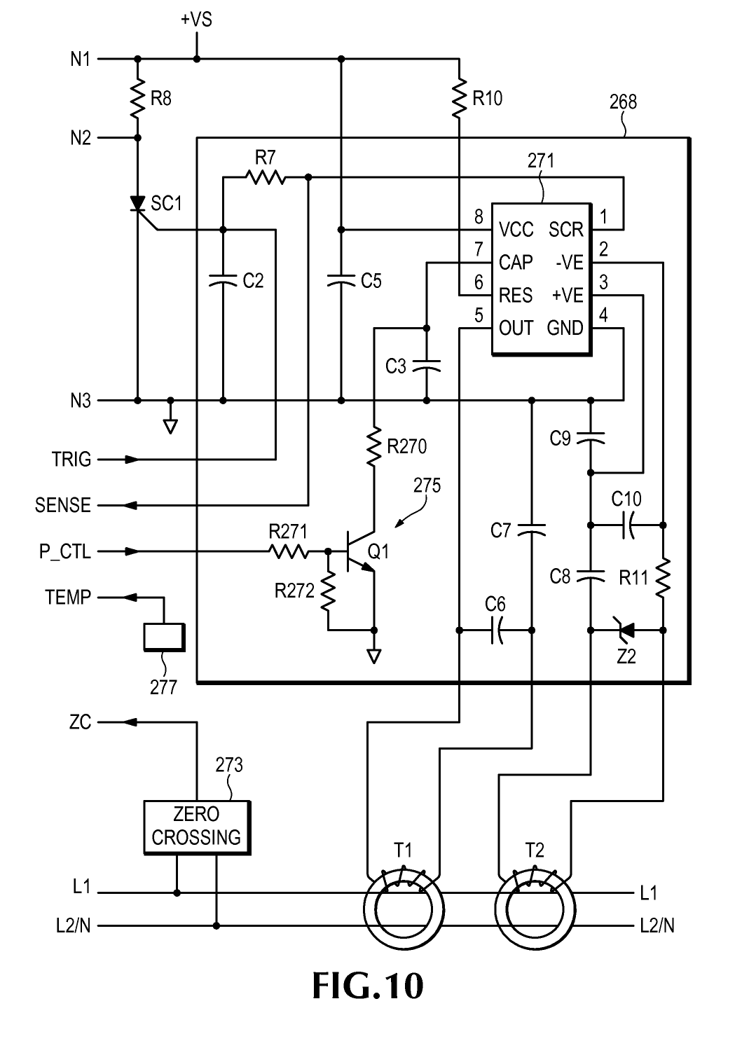

FIG. 10 illustrates an example embodiment of a ground fault detection circuit having self-test functionality according to some inventive principles of this patent disclosure. The embodiment of FIG. 10 includes a ground fault interrupter circuit 269 which illustrates some possible implementation details for the ground fault interrupter circuit 268 of FIG. 7, and further includes additional circuitry to enable self-test functionality. A GFCI integrated circuit (IC) 271, which in this example may be an LM1851 or FAN1851, receives the local power supply +VS through a VCC terminal (pin 8). A supply capacitor C5 decouples the IC 271 from noise in the supply and provides energy storage. The IC is referenced to the local ground through the GND terminal (pin 4). Connections N1, N2 and N3, as well as conductors L1 and L2/N and transformers T1 and T2 illustrate how the embodiment of FIG. 10 may be arranged within an EVSE system such as the embodiment of FIG. 7.

Ground/Neutral transformer T1 is connected to the IC through a capacitor network including C6 and C7. The differential sense transformer T2 is connected to the IC through a network including capacitors C8-C10, resistor R11 and voltage regulator diode Z2.

The differential fault current threshold (sensitivity) for the IC is determined by the current flowing into the RES terminal (pin 6) through resistor R10. The timing or integrating capacitor C3 is charged by a fault current when the IC 271 detects a fault condition. When the voltage on C3 reaches a predetermined limit, the SCR output (pin 1) is driven high which triggers the SCR SC1 through resistors R7 and capacitor C2, which provides noise protection from accidental triggering.

To simulate a fault condition during an automatic testing process, a fault simulation circuit such as the auto test circuit including R15, RL3 and R14 shown in FIG. 7 may be included. As another example, a fault may be simulated by using a rectifier bridge connected to L1 and L2/N, a voltage dropping resistor, and a transistor referenced to the local ground and controlled by a microcontroller or other self-test controller as described below.

A trigger connection TRIG may be provided to the gate of SC1 to enable the self-test controller to control SC1. For example, the TRIG connection may have three different states: a high-impedance state that enables the IC 271 to control SC1 as it normally would in a conventional operating mode; a low output or pull-down state that clamps the gate of SC1 to a low level to prevent it from triggering even if the IC 271 tries to trigger it; and a high output or pull-up state that triggers SC1 regardless of the state of the output (pin 1) of the IC 271.

A sense connection SENSE may be provided to enable the self-test controller to read the state of the SCR output (pin 1) of the IC 271.

A timing circuit 275 includes a transistor Q1 which turns on in response to a signal P_CTL and discharges the timing capacitor C3 through a resistor R270. This causes the timing capacitor to discharge more rapidly than it normally would under the control of the IC 271.

A zero crossing detection circuit 273 generates a zero crossing signal ZC which may enable a self-test controller to determine when the AC input voltage on L1 and L2/N crosses zero, as well as other information such as the line voltage, polarity of a half-cycle, etc. The zero crossing detection circuit may be implemented, for example, with a resistive voltage divider connected to the AC input voltage and referenced to the local ground node. If used in combination with a zero crossing detector, the optocoupler RL3 may be used to apply a fault condition to the system during any selected portion of a line cycle or half-cycle.

In some embodiments, the self-test controller may be implemented as a dedicated controller. In other embodiments, the self-test control functionality may be integral with other control functionality such as that provided by the controller 262 illustrated in FIGS. 4 and 5. Any or all of the signals TRIG, SENSE, P_CTL and ZC may be isolated from the self-test controller using optical isolation, magnetic isolation, etc. For example, optical isolators such as U2, U3, U19 and RL3-RL6 may be used to couple the signals TRIG, SENSE, P_CTL and ZC to the microcontroller 270 of FIG. 5 to enable the microcontroller to control a self-test process for the embodiment of FIG. 10.

The apparatus illustrated in FIG. 10 may enable the implementation of various types of self-test functionality according to the inventive principle of this patent disclosure. For example, in some embodiments, the self-test controller may drive the TRIG signal low, thereby preventing the IC 271 from triggering the SCR during a self test. The state of the SENSE signal may then be monitored while a simulated fault is applied to the system. The simulated fault may cause the timing capacitor C3 to charge at a lower rate than an actual external fault. If the SENSE signal is activated within a predicted time window, the controller determines that the IC 271 is operating properly in response to the simulated fault signal. The self-test controller then releases the TRIG signal to enable the IC 271 to operate normally.

If, however, the SENSE signal is activated earlier than expected, this may indicate that an actual external fault condition exists. The self-test controller may then release the TRIG signal immediately to enable IC 271 to trigger the SCR and open the contacts. Alternatively, the self-test controller may activate the TRIG signal to trigger the SCR and open the contacts.

In some embodiments, the self-test controller may activate the P_CTL signal at the end of a self-test process to enable the timing circuit 275 to rapidly discharge the timing capacitor C3. This may reduce the time required to put the fault circuit back online for detecting actual faults once a self test is completed.

In some embodiments, the self-test controller may be programmed to perform a self test across at least two different half cycles of opposite polarity. The determination of the timing of the self test may be based upon timing performed by the self-test controller in combination with the zero crossing detection circuit 273. Both the polarity and timing of a zero crossing are detected with the help of the zero crossing circuit 273. If a self test is conducted during the existence of an external fault that was below a trip limit, then this condition could result in a false failure of a self test. Because the system may be configured to conduct the self test across at least two different half cycles of opposite polarity, this self test may not be affected by the presence of a standing external fault. This is because with at least one of the embodiments described above, the self test simulated fault signal may be a rectified fault signal. If during the self test, the SENSE signal goes high at the half cycle or during a period of time when a test fault is not applied, this means that an external fault caused the tripping and the self-test controller will unblock the SCR to allow the IC chip 271 to trip the solenoid.

During charging, the voltage on timing capacitor C3 grows, and when it reaches its threshold value, pin 1 on the IC 271 goes high, and causes triggering of the SCR SC1. The triggering of the SCR provides current to the pilot solenoid RL2 of FIG. 8, triggering the opening of the contacts in RL1 and removing the external fault from the line. Essentially, anyone of the components including the pilot solenoid RL2, the SCR, and the relay RL1 comprise a line interrupting circuit or disconnect device. Once the contacts have unlatched or opened, the capacitor C3 charging current disappears and it is discharged by a current set by resistor R10. After the voltage on capacitor C3 goes below the predetermined voltage level, pin 1 on fault detector IC 271 returns back to a low level. In at least one embodiment, to shorten the time period required to discharge timing capacitor C3, additional circuitry including timing circuit 275 is coupled to capacitor C3 which reduces this discharge time.

In some embodiments, the SENSE signal from the fault detection IC 271 is coupled to the self-test controller to enable the controller to determine that the fault detector IC 271 has detected a fault. In this case, during a fault, either external or internal, when fault detector IC 271 generates a fault signal, the output from fault detector IC 271 flows not only to the SCR but also to the self-test controller to indicate to the self-test controller that a fault has occurred. The SENSE input to the self-test controller is significant because if during a test cycle, there is no active signal from pin 1 of fault circuit IC 271 into the self-test controller, then this result would provide an initial indication that fault circuit IC 271 has failed or at least that another component monitored by the self test has failed. In this case, self-test controller is programmed to conduct a self test over at least two different half cycles of different polarities. In at least one embodiment, these different half cycles can be consecutive half cycles. The simulated fault signals that are generated are introduced by the self-test controller in combination with the fault simulator such as RL3 in FIG. 7 on at least a portion of a first half cycle and then on a portion of at least a second half cycle. The duration of this self test is sufficient to charge capacitor C3 to then cause the creation of a fault signal. If after a self-test cycle, which occurs across at least two different polarities of the AC line voltage, no SENSE signal is received into the self-test controller, then this would indicate failure of at least one component of fault circuit 269, e.g. fault detector IC 271. Because there is testing of the fault circuit during both polarities, there would be lower likelihood of false failure indication of a self test, because the simulated fault signals occur across both polarities thereby avoiding any result of out of phase simulated fault signals being reduced or canceled out.

In some embodiments, a temperature sensor 277 may be included. The temperature sensor 277 can comprise a circuit utilizing a resistor, a thermistor, or any other known sensor circuitry for determining the ambient temperature of the device. If necessary, the self-test controller can include an additional connection to this temperature sensor to form a closed circuit. The temperature sensor is used to determine the ambient temperature of the device, wherein the self-test controller includes programming to trip the contacts in the event it detects that an operating temperature, or an ambient temperature sensed by temperature sensor 277 is too high or too low.

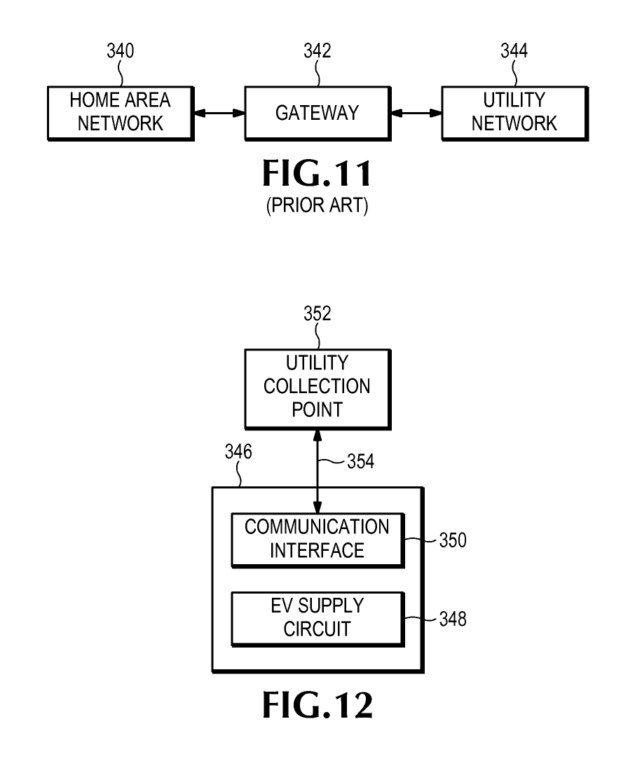

Some additional inventive principles of this patent disclosure relate to communications between EVSE and a utility. FIG. 11 illustrates a prior art arrangement in which a home area network (HAN) 340, which may include one or more smart appliances or other smart home apparatus, communicates with a utility network 344 in a smart grid application. A gateway 342 is used to convert the protocols used by the HAN and utility networks so that information can be passed from one network to the other. For example, the HAN may use Wi-Fi while the network utility may use ZigBee Smart Energy 1.0. Thus, the gateway 342 must be able to convert between these different protocols.

FIG. 12 illustrates an embodiment of an apparatus and system according to some inventive principles of this patent disclosure. The apparatus 346 includes an electric vehicle supply circuit 348 and a communication interface 350 coupled to the electric vehicle supply circuit. The communication interface 350 is adapted to communicate with a utility collection point 352 through communication link 354 using substantially the same protocol as the utility collection point. Thus, the system may operate without a gateway. The communication interface may include a wireless communication interface such as a ZigBee Smart Energy interface or other interface using spread spectrum or other wired or wireless technology. Using a ZigBee Smart Energy 2.0 wireless interface may facilitate a direct link to a utility without the need for a gateway. The communications may pass through one or more servers or routers between endpoints without being processed by a gateway that translates protocols.

The electric vehicle supply circuit 348 may be realized with any suitable circuitry including, for example, any of the embodiments described above and illustrated with respect to FIGS. 5-10. The apparatus 346 may be adapted to send requests to, and respond to communications from, the utility collection point 352. For example, the apparatus may be adapted to provide demand response functions such as load shedding in response to the communications from the utility collection point. As another example, the apparatus may be adapted to provide billing rate response functions in response to the communications from the utility collection point. Examples of billing rate response functions include charging during certain times to facilitate off-peak rate reductions, and discounted rates for charging electric vehicles.

The apparatus 346 may be realized in any suitable form including a Level 1 EVSE cord set or hardwired device, a Level 2 EVSE device, a portable apparatus such as a plug-in adapter, etc. In some embodiments, the apparatus 346 may include a revenue-grade (or utility-grade) meter to enable power usage reporting and revenue collection through the communication link 354 between the apparatus 346 and the utility collection point 352.

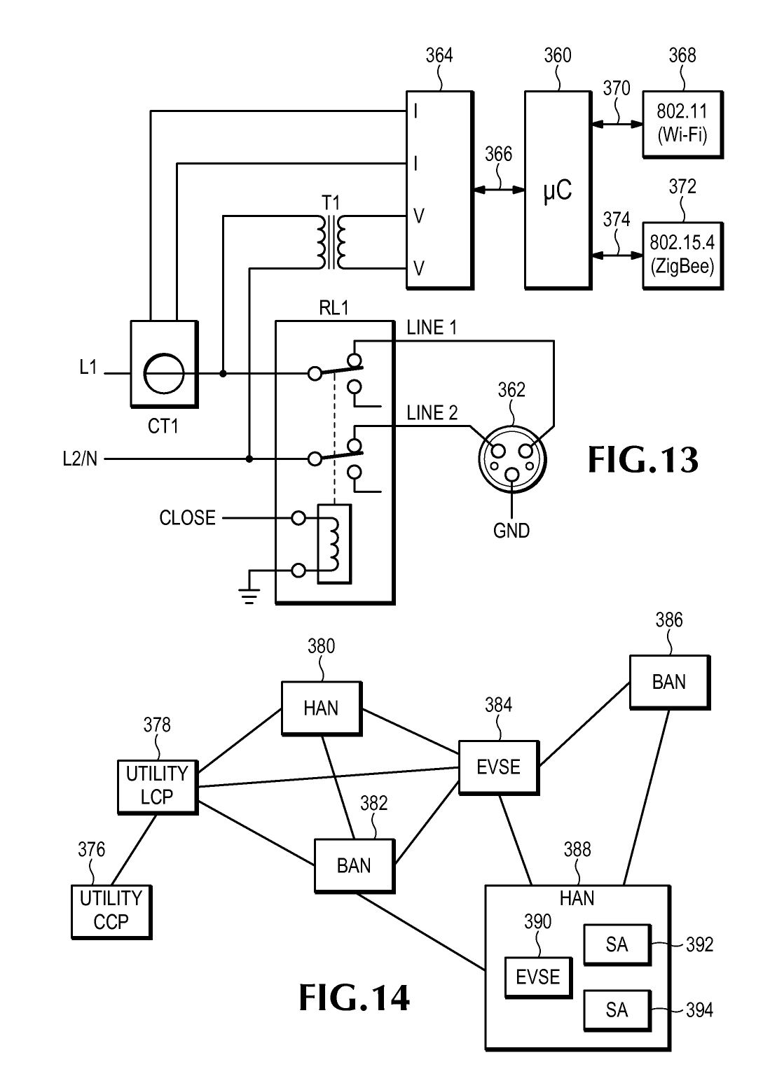

FIG. 13 illustrates an embodiment of an EVSE system according to some inventive principles of this patent disclosure. In embodiment of FIG. 13, centralized control is provided by a microcontroller 360 which may be, for example, a Microchip PIC24. AC power is provided to the system on the L1 and L2 or L1 and N conductor pairs. The flow of power to the vehicle charging connector 362 is controlled by a contactor or relay RL1 in response to a signal CLOSE which may be optically or magnetically isolated from the microcontroller 360 through any suitable isolation technology.

Revenue-grade (or utility-grade) metering is provided by a metering IC 364 such as a Microchip MCP3909, a Teridian 71M65xx, or any other suitable device. The metering IC detects load current and voltage through a current transformer CT1 and voltage transformer T1, respectively. The output from the voltage transformer T1 may also be used to generate one or more DC power supplies for the microcontroller 360 and other support circuitry. A manual or air-gap switch may also be connected in series with the relay RL1. The metering IC may communicate with the microcontroller 360 through a serial interface 366 or any other suitable interface.

Communications capabilities may be provided by one or more network interface modules, ICs, etc. In the example embodiment of FIG. 13, Wi-Fi (IEEE 802.11) connectivity may be provided by a Wi-Fi interface module 368 which may be based, for example, on a ZG2100M module from ZeroG Wireless. Additionally, or alternatively, IEEE 802.15.4 connectivity may be provided by a wireless module 372 which may be based, for example, on a Freescale MC1322x Series ARM7 processor with integrated IEEE 802.15.4 functionality that supports ZigBee type protocols. The one or more modules may communicate with the microcontroller 360 through serial interfaces 370 and/or 374.

Using the ZigBee Smart Energy 2.0 standard may enable Wi-Fi compatible wireless connectivity through the ZigBee module 372. This may reduce the overall system cost, design effort, power consumption and system requirements, while still providing the flexibility of Wi-Fi connectivity.

The embodiment of FIG. 13 may also include functionality to enable the EVSE to function as a node for a mesh network. Such functionality may be provided, for example, in the microcontroller 360 and/or software and/or firmware, and/or in one or more of the communication interfaces 368 and 372. The mesh network may be a wired, wireless or hybrid mesh network.

FIG. 14 illustrates an example embodiment of a mesh network system according to some inventive principles of this patent disclosure. The embodiment of FIG. 14 is primarily a wireless network and includes a utility local collection point (LCP) 378 that collects and transmits data to/from nodes 380, 382, 384, 386 and 388 on the mesh network. Although only one LCP is shown in FIG. 14, any number of LCPs maybe included. The one or more LCPs act as feeders to a utility central collection point (CCP) 376.

Nodes 380 and 388 are comprised of, or included in, home area networks (HANs), while nodes 382 and 386 are comprised of, or included in commercial building area networks (BANs). EVSE 384, which may be realized for example with the embodiment of FIG. 13, may also function as a node on the mesh network. Moreover, mesh-capable EVSE according to some inventive principles of this patent disclosure may be included as a sub node within a HAN, BAN or other node. HAN node 388, for example, includes mesh-capable 390, as well as smart appliances (SAs) 392 and 394.

Depending on the implementation, EVSE with the ability to function as a node in a mesh network may provide various benefits. For example, an EVSE system may be the first mesh-capable device introduced into a certain household in a neighborhood. This may greatly expand the interconnectivity and reach of a utility mesh network. This may be understood by reference to FIG. 14 where building area network 386 may be out of range of the local collector point 378. Introducing mesh-capable EVSE 384 may enable building area network 386 to communicate with LCP 378. Thus, through the proliferation of mesh-capable EVSE in a neighborhood, the cost, and/or number and/or range of LCP required for the neighborhood may be reduced, and/or the range of the entire mesh network may be extended to a greater geographic region. Moreover, the introduction of additional mesh-capable EVSE nodes may improve the reliability of the entire mesh network by providing alternative communication paths if other nodes are removed, or otherwise become nonfunctional.

As with other embodiments described above, the mesh-capable EVSE nodes 384 and 390 may be realized in any suitable physical form including a Level 1 EVSE cord set or hardwired device, a Level 2 EVSE device, a portable apparatus such as a plug-in adapter, etc. The communication technology may be based on a ZigBee Smart Energy interface or other interface using spread spectrum or other wired or wireless technology. Using a ZigBee Smart Energy 2.0 wireless interface may facilitate a direct link to a utility without the need for a gateway.

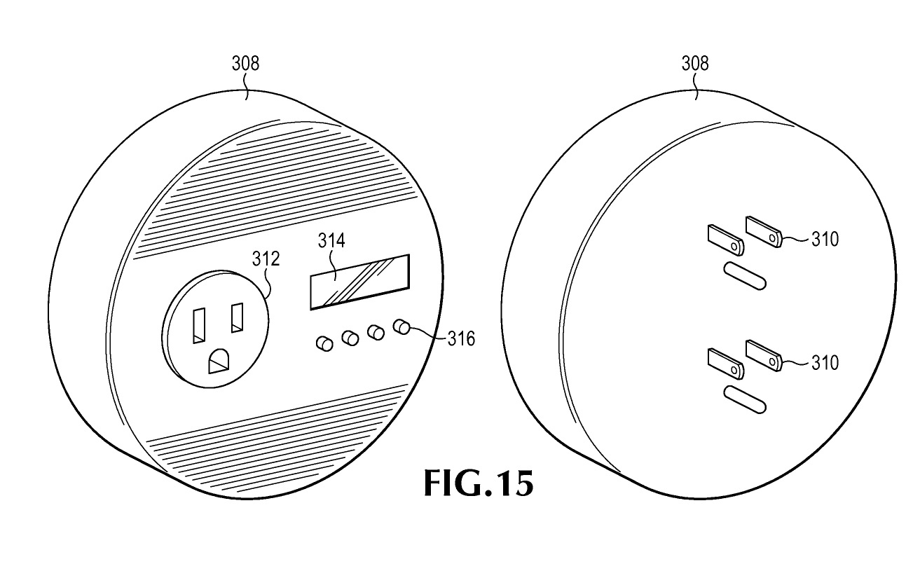

FIG. 15 illustrates an embodiment of a plug-in EVSE device according to some inventive principles of this patent disclosure. The device of FIG. 15 includes a housing 308 having one or more sets of blades 310 or other connections on a back for plugging the device into one or more receptacles. The device also includes a receptacle 312 on the front to provide power to a vehicle through a charging cord. Any type and extent of vehicle supply circuitry may be included within the device.

For example, in one embodiment the device may not be able to disconnect the receptacle 312 from the blades 310. The device may only have monitoring circuitry to display charging voltage, current, power, etc., on a display 314. Buttons 316 may enable a user to select a parameter to view, scroll through various parameters or menu items, etc.

In another embodiment, the plug-in device of FIG. 15 may include a charging circuit interrupting device (CCID) to interrupt power to the receptacle 312 if a ground fault is detected. Another embodiment may include a CCID and a grounding monitor to enable the trip point of the CCID to be set to a relatively high level.

In other embodiments, the device of FIG. 15 may include any or all of the manual and/or automatic testing and/or monitoring features described above with respect to the embodiments of FIGS. 3-10.

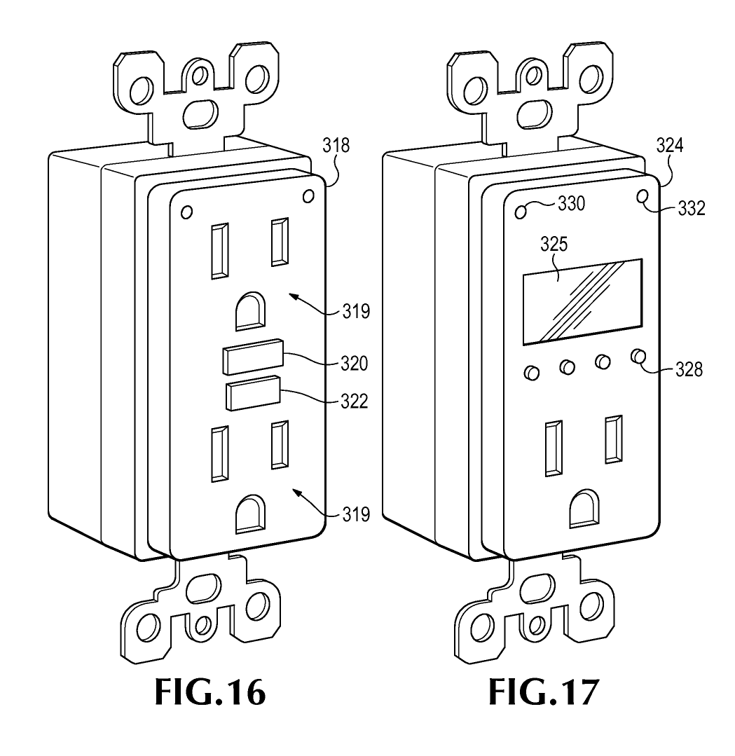

FIG. 16 illustrates an embodiment of an EVSE wiring device according to some inventive principles of this patent disclosure. The embodiment of FIG. 16 has a housing 318 with a form factor and circuitry that is similar to a standard GFCI wiring device (or arc-fault circuit interrupter (AFCI), equipment leakage circuit interrupter (ELCI), overcurrent, overvoltage, or any other suitable circuit interrupter). However, a grounding monitor circuit is added to enable the ground fault trip point to be set to a relatively high level to accommodate vehicle charging. A vehicle may be plugged into the device with a charging cord having a plug that fits into one of the receptacles 319. Test and reset buttons 320 and 322 are located on the front. In some embodiments, the ground fault detection and grounding monitor functionality may have manual test and reset features. In other embodiments, one or both of the ground fault detection and grounding monitor functionality may include automatic test and/or reset features such as those described above with respect to FIGS. 3-10.

FIG. 17 illustrates another embodiment of an EVSE wiring device according to some inventive principles of this patent disclosure. The embodiment of FIG. 17 has a housing 324 with a form factor similar to the embodiment of FIG. 16. However, one of the front receptacles is replaced with a display 325 and buttons 328 which may have functionality similar to that described above with respect to FIG. 15. Additionally, the embodiment of FIG. 17 may include one or more indicators 330 and 332 such as LEDs, lamps, audio indicators, tactile indicators, etc., to indicate vehicle charging state, fault conditions, etc. As with the embodiments of FIGS. 15 and 16, any type and extent of vehicle supply circuitry may be included within the device.

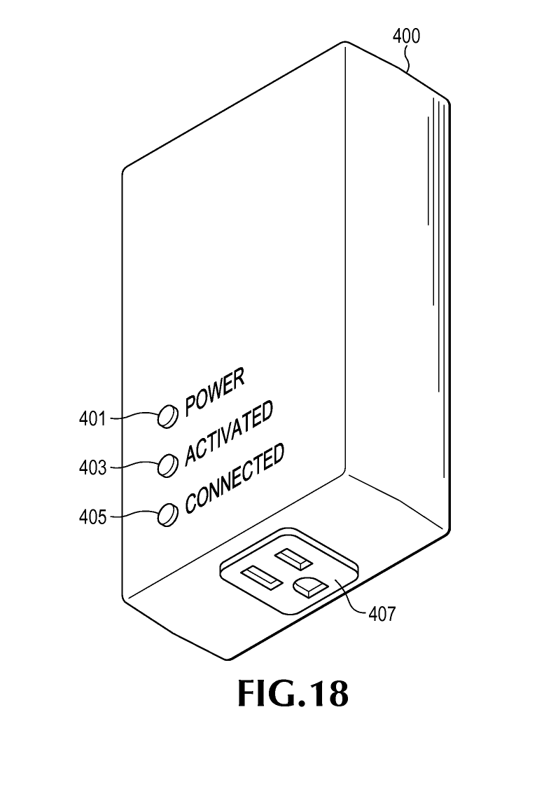

FIG. 18 illustrates another example EVSE apparatus according to some inventive principles of this patent disclosure. In this example, the electric vehicle supply circuit is housed in a plug-in adapter 400 having connector blades on the back similar the embodiment of FIG. 15. The embodiment of FIG. 18 also includes a receptacle 407, although the unit may also be implemented as a cord set by replacing the receptacle with a cord and vehicle charging connector.

The EVSE of FIG. 18 also includes three indicators including a power indicator 401 that indicates when AC power is applied to the unit and an active indicator 403 that indicates when AC power is applied to the receptacle 407 and/or vehicle charging connector. For example, if the unit is implemented with the circuit of FIG. 13, the active indicator 403 may be configured to illuminate when the contactor or relay RL1 is closed. Another indicator 405 indicates when a wireless connection is established by the unit.

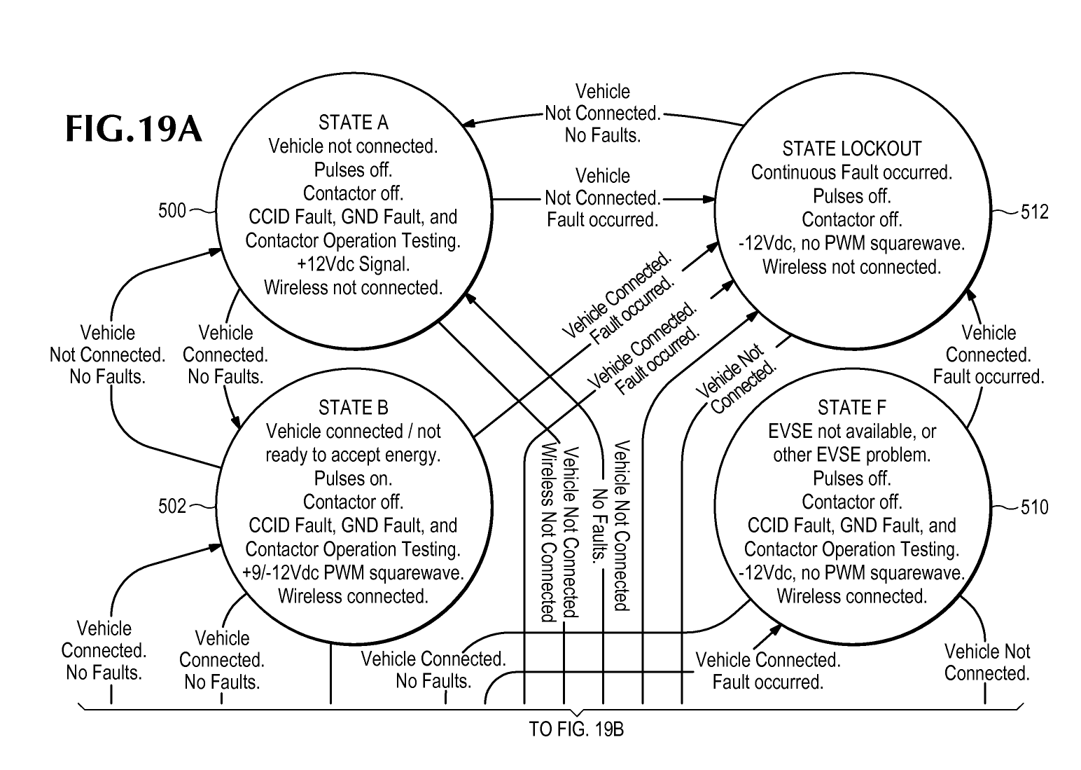

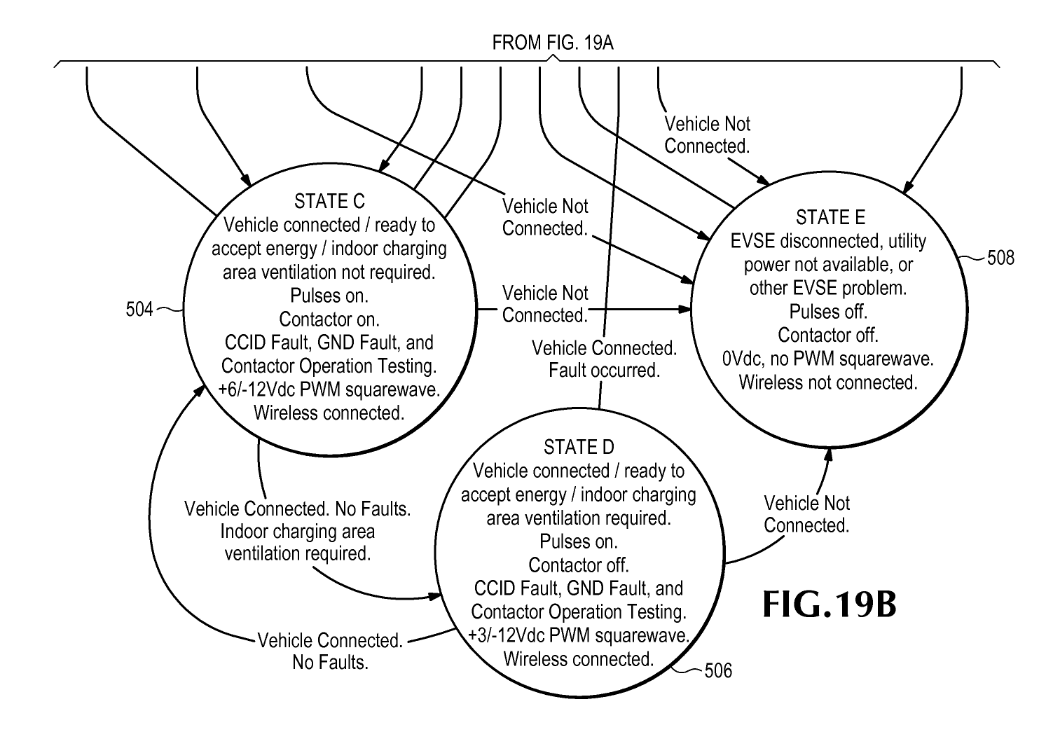

FIG. 19 is a state diagram that illustrates the operation of an embodiment of an EVSE system according to some inventive principles of this patent disclosure. The embodiment of FIG. 19 is illustrated in the context of a system that implements the definitions of vehicle states for a control pilot circuit as defined in SAE J1772, but with additional features including wireless communication functionality as described below. The inventive principles, however, are not limited to these implementation details. The embodiment of FIG. 19 may be implemented, for example, using the system described above with respect to FIG. 13.

Referring to FIG. 19, in State A, which is shown as element 500, a vehicle is not connected to the EVSE and therefore, the contactor is off, and no pulses are driven onto the control pilot conductor which is maintained at a 12 VDC nominal voltage. As long as AC input power is available, however, the EVSE continues to perform the CCID Fault, Ground Fault and Contactor Operation testing. In State A, no wireless connection is established between the EVSE and a utility, user, monitoring system, or other networked device.

The system enters State B shown as element 502 if a vehicle is connected to the EVSE and no faults are detected. In State B, the contactor is off, a 1 KHz pulse train is applied to the control pilot conductor with pulse width that indicates the current available from the EVSE. The vehicle charge control circuit maintains the pulses at +9/−12 VDC to indicate that the vehicle is not ready to accept energy. In State B, a wireless connection is established with utility, user, monitoring system, or other networked device. The system may return to State A and terminate the wireless connection if the vehicle is disconnected from the EVSE and no faults are detected.

The system enters State C shown as element 504 if the vehicle remains connected, no faults are detected, and the vehicle charge control circuit maintains the pulses at +6/−12

VDC to indicate that the vehicle is ready to accept energy and that no indoor charging area ventilation is required. In State C, the contactor is turned on, and the wireless connection is maintained.

State D, which is shown as element 506 is similar to State C except that the vehicle charge control circuit maintains the pulses at +3/−12 VDC to indicate that the vehicle is ready to accept energy, but indoor charging area ventilation is required. In State D, the contactor is turned on after the EVSE provides a signal to turn on the ventilation if the EVSE is listed for indoor charging of vehicles.

The EVSE may enter State E shown as element 508 from several different states if the EVSE is disconnected, utility power is not available, or another EVSE problem is detected. In State E, no pulses are driven onto the control pilot conductor which is maintained at a 0 VDC nominal voltage. The wireless connection is terminated, and the contactor is turned off.

The system enters State F shown as 510 if a fault occurs while the vehicle is connected. For example, the EVSE may not be available or another EVSE problem may occur. In State F, no pulses are driven onto the control pilot conductor which is maintained at a −12 VDC nominal voltage. The wireless connection is maintained, but the contactor is turned off.

A lockout state 512 may be entered when a continuous fault is detected. In the lockout state, no pulses are driven onto the control pilot conductor which is maintained at a −12 VDC nominal voltage. The wireless connection is terminated, and the contactor is turned off.

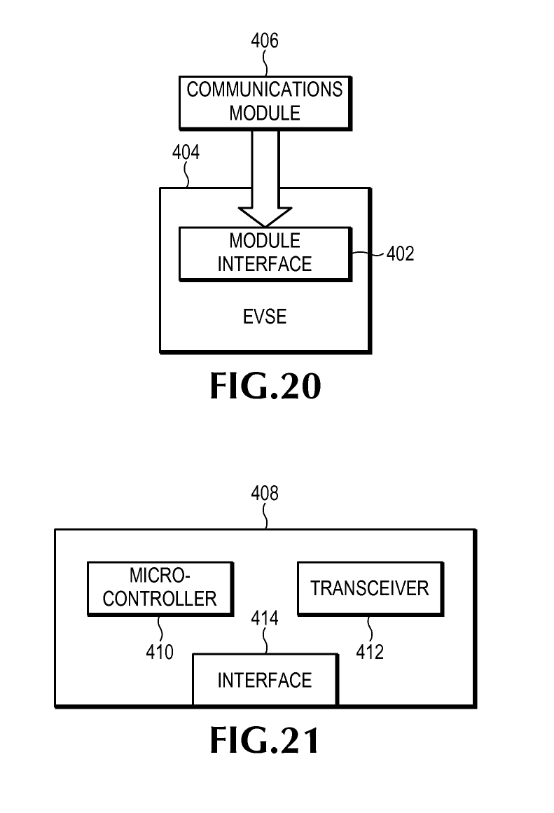

FIG. 20 illustrates an embodiment of an EVSE system having modular communications according to some inventive principles of this patent disclosure. The EVSE 404 includes a module interface 402 to enable the EVSE to operate with one or more different communication modules 406. A communication module may implement any wired or wireless, standardized, custom and/or proprietary communication platform and/or protocol. Examples include IEEE 802.11 (e.g., WiFi), any implementation of ZigBee Wireless including Smart Energy, Z-Wave, etc.

The interface 402 may include any suitable mechanical interface to accept a communication module including a slot, bay, socket, etc., and any suitable electrical interface to enable the EVSE to communicate through the module including a card-edge connector, plug and receptacle, ribbon cable, etc., to establish serial data connection, parallel data connection, etc. with the module. A module may be realized in any suitable mechanical and/or electrical form to operate with the interface.

Having modular communications may provide a flexible solution that enables the EVSE to adapt to changing market conditions, supply conditions, user preferences and/or needs, etc. For example, a specific type of communication protocol such as Z-Wave may be popular in a particular market where the local utility is promoting a new standard such as ZigBee Smart Energy 2.0. The local utility may require new EVSE to include the new standard, but hardware for the new standard may not be widely available yet, it may be prohibitively expensive, or it may lack user acceptance. By providing a modular interface, an EVSE manufacturer or supply may initially ship a unit with the more common or acceptable Z-Wave module, but still enable the conversion to the new standard when required by the utility or accepted by the user.

FIG. 21 illustrates an example embodiment of a module having WiFi capability according to some inventive principles of this patent disclosure. The module 408 includes a microcontroller 410, and an interface 414 to connecter to the interface 402 on the EVSE. The module may include a single-chip WiFi transceiver 412 such as a ZeroG ZG2100 chip to provide a high level of functionality at low power consumption levels. The transceiver may include power management hardware and/or software to reduce power consumption of both the transceiver and the host microcontroller to meet the needs of a wide variety of applications.

The inventive principles relating to WiFi may be implemented even without a modular interface. Current EVSE products typically have non-WiFi communication such as ZigBee, which is oriented to specialized applications such as automation and control systems and cannot interoperate with WiFi. However, WiFi has become popular with the general public WiFi routers have been installed in homes and businesses on a widespread basis. To promote acceptance of electric vehicles by the general public, it may be advantageous to enable consumers to interact with EVSE through a familiar interface such as WiFi. Thus, some of the inventive principles contemplate an embodiment of an EVSE system with a WiFi interface, which may be modular or built into the EVSE, that enables a user to check, for example, the charge status of an electric vehicle from a WiFi enabled computer or phone, while utilizing existing WiFi infrastructure.

Another embodiment of a communication module according to some of the inventive principles may operate on any version of the ZigBee Smart Energy standard including version 2.0. Such an embodiment may combine wireless and power line carrier (PLC) technology in a modular form that may be utilized for locations or utilities that require a ZigBee interface.

Another embodiment of a communication module according to some inventive principles may provide Z-Wave compatible functionality. An benefit of a Z-Wave compatible module is that is may enable an EVSE to interoperate with a wide range of existing products such as remote controls, serial communication modules, etc., many of which may be consumer oriented products that users may have developed a level of comfort and acceptance with.

The inventive principles of this patent disclosure have been described above with reference to some specific example embodiments, but these embodiments can be modified in arrangement and detail without departing from the inventive concepts. For example, even though some example embodiments are described in the context of EVSE systems, the inventive principles may also be applied to other types of power distribution systems. Thus, any changes and modifications are considered to fall within the scope of the following claims.

1. An apparatus comprising:
an electric vehicle supply circuit; and
a communication interface in electrical communication with the electric vehicle supply circuit;
where the apparatus is adapted to function as a node for a network.

2. The apparatus of claim 1 where the apparatus is adapted to function as a node for a wireless mesh network.

3. The apparatus of claim 2 where the communication interface comprises a spread-spectrum wireless interface.

4. The apparatus of claim 3 where the communication interface comprises a ZigBee Smart Energy interface.

5. The apparatus of claim 2 where the apparatus comprises a portable apparatus.

6. The apparatus of claim 5 where the portable apparatus comprises a plug-in adapter.

7. An apparatus comprising:
an electric vehicle supply circuit; and
a communication interface in electrical communication with the electric vehicle supply circuit;
where the communication interface is adapted to communicate with a utility collection point using substantially the same protocol as the utility collection point.

8. The apparatus of claim 7 where the communication interface comprises a wireless communication interface.

9. The apparatus of claim 8 where the wireless communication interface comprises a ZigBee Smart Energy interface.

10. The apparatus of claim 7 where the apparatus is adapted to respond to communications from the utility collection point.

11. The apparatus of claim 10 where the apparatus is adapted to provide demand response functions in response to the communications from the utility collection point.

12. The apparatus of claim 11 where the apparatus is adapted to provide billing rate response functions in response to the communications from the utility collection point.

13. The apparatus of claim 7 where the apparatus comprises a portable apparatus.

14. The apparatus of claim 13 where the portable apparatus comprises a plug-in adapter.

15. The apparatus of claim 7 where the apparatus comprises a revenue-grade meter circuit.

16. An apparatus comprising:
an electric vehicle supply circuit;
a revenue-grade meter in electrical communication with the electric vehicle supply circuit; and
a wireless communication interface in electrical communication with the electric vehicle supply circuit to enable the apparatus to communicate with a utility.

17. The apparatus of claim 16 where the wireless communication interface comprises a spread-spectrum communication interface.

18. The apparatus of claim 16 where the communication interface is adapted to communicate with a utility collection point using substantially the same protocol as the utility collection point.

19. An apparatus comprising:
an electric vehicle supply circuit; and
a wireless communication interface in electrical communication with the electric vehicle supply circuit;
where the apparatus is adapted to control the wireless communication interface in response to the state of the electric vehicle supply circuit.

20. The apparatus of claim 19 where the apparatus is adapted to establish a connection through the wireless communication interface in response to coupling the electric vehicle supply circuit to a vehicle.

21. The apparatus of claim 19 where the apparatus is adapted to terminate a connection through the wireless communication interface in response to a vehicle fault condition.
